(19) United States
(12) Patent Application Publication
(10) Pub. No.: US 2026/0367420 A1
(43) Pub. Date: Nov. 19, 2026

(54) Flexible Clip-on for Flexible Eyewear

(71) Applicant: Brent SHELDON, Miami, FL (US)

(72) Inventors: Brent SHELDON, Miami, FL (US); Guy BROUSSEAU, JR., Marieville (CA)

(21) Appl. No.: 19/740,978

(22) Filed: Jul. 14, 2026

Related U.S. Application Data
(63) Continuation of application No. PCT/CA2025/050106, filed on Jan. 27, 2025.
(60) Provisional application No. 63/549,167, filed on Feb. 2, 2024.
(60) Provisional application No. 63/696,106, filed on Sep. 18, 2024.

(51) Int. Cl. G02C 5/06; G02C 9/04

(52) U.S. Cl. CPC G02C 5/06; G02C 9/04; G02C 2200/02

(57) ABSTRACT

An eyewear assembly, comprising: primary eyewear, the primary eyewear comprising a first pair of frame portions configured to contain a first pair of lenses, the first pair of frame portions connected to each other via a first flexible bridge portion; and auxiliary eyewear, the auxiliary eyewear comprising a second pair of frame portions configured to contain a second pair of lenses, the second pair of frame portions connected to each other via a second flexible bridge portion; wherein the first and second pairs of frame portions are releasably attachable to each other via an engagement mechanism; and wherein the first and second flexible bridge portions are substantially aligned with each other when the first and second pairs of frame portions are engaged with each other to permit the primary and auxiliary eyewear to bend in unison while maintaining engagement with each other.

### CROSS-REFERENCE TO RELATED APPLICATIONS

This application is a Continuation of PCT Application No. PCT/CA2025/050106 filed Jan. 27, 2025, which claims priority to U.S. Provisional Patent Application Nos. 63/549,167 filed on Feb. 2, 2024 and 63/696,106 filed on Sep. 18, 2024, the contents of which are incorporated herein by reference in their entirety.

### TECHNICAL FIELD

The following generally relates to clip-on or other attachments for eyewear and, in particular, to flexible clip-ons and similar attachments for flexible eyewear to enable deformation of the clip-on with the flexible eyewear.

### BACKGROUND

Eyewear such as eyeglasses generally include a frame that supports one or more lenses. The frame typically includes a nose bridge or nose pieces that engage the user's nose to support the eyewear on the user's head. Eyeglasses also typically include a pair of arms attached to (or integral with) the frame, to further support the eyeglasses, e.g. by resting the arms on the user's ears or engaging their head in the temple region. Other eyewear may include other support elements such as straps or bands (e.g., in sports goggles).

Eyeglasses have traditionally utilized frames made from substantially rigid materials such as plastics, metals, or composite materials. The rigidity of these materials supports the lenses in the frames, and substantially maintains the shape of the eyeglasses such that they consistently fit on a user's head as intended. A drawback of this rigidity is that the frames can only typically withstand some flexure and can be prone to breakage or deformation.

Flexible components have been used in eyewear, for example, flexible arms and flexible portions of the eyewear frames. Various challenges can arise in construction, assembly, and use when incorporating flexible elements. For example, the flexibility should not cause the frames to deform and thus lose their shape over time.

### SUMMARY

Currently, clip-on frames or other attachments or auxiliary frames that releasably attach to a primary eyewear create challenges with fitting on the primary eyewear. For example, gaps may be created because of the fitment of the clip-on to the frame. Moreover, the clip-ons may require adjustment based on the primary eyewear and its geometry, whether to keep the clip-on secured on the primary frame or to accommodate some flexure of the primary frame. This is further challenged when the primary frame has significant flexibility (e.g., high degrees of bending or twisting). To overcome these challenges, a flexible auxiliary attachment, herein also referred to as a clip-on or clip-on attachment adopts a flexible bridge portion that aligns with and permits bending along the main flexible component of such flexible primary eyewear, namely the bridge portion of the primary eyewear. This not only avoids dislodgement but also avoids a gap between the clip-on and the primary frame.

In one aspect, there is provided flexible auxiliary eyewear configured to be releasably attached to flexible primary eyewear by including at least a portion of flexible material that is aligned with a flexible portion of the flexible primary eyewear.

In certain example embodiments, the flexible auxiliary eyewear comprises a flexible bridge portion that deforms to follow the deformation permitted by the flexible primary eyewear to maintain the auxiliary eyewear flush to a front surface of the primary eyewear frame.

In certain example embodiments, the flexible bridge portion permits bending and twisting to follow bending and twisting permitted by the flexible primary eyewear.

In certain example embodiments, the flexible auxiliary eyewear includes an engagement mechanism to couple the flexible auxiliary eyewear to the flexible primary eyewear.

In certain example embodiments, the engagement mechanism comprises magnetic attraction.

In certain example embodiments, the engagement mechanism comprises one or more clips.

In certain example embodiments, the engagement mechanism is positioned at a plurality of portions of a frame of the flexible auxiliary eyewear.

In certain example embodiments, the engagement mechanism is positioned at least in part along a portion of the flexible portion of the flexible auxiliary eyewear.

In certain example embodiments, the flexible bridge portion comprises a length that substantially spans the same length as a flexible bridge portion of the flexible primary eyewear.

In certain example embodiments, the flexible auxiliary eyewear comprises a surface that is contoured to follow contouring of a front face of the flexible primary eyewear.

In another aspect, there is provided an eyewear assembly comprising the flexible auxiliary eyewear as defined above, and the flexible primary eyewear.

In another aspect, there is provided an eyewear assembly, comprising: primary eyewear, the primary eyewear comprising a first pair of frame portions configured to contain a first pair of lenses, the first pair of frame portions connected to each other via a first flexible bridge portion; and auxiliary eyewear, the auxiliary eyewear comprising a second pair of frame portions configured to contain a second pair of lenses, the second pair of frame portions connected to each other via a second flexible bridge portion; wherein the first and second pairs of frame portions are releasably attachable to each other via an engagement mechanism; and wherein the first and second flexible bridge portions are substantially aligned with each other when the first and second pairs of frame portions are engaged with each other to permit the primary and auxiliary eyewear to bend in unison while maintaining engagement with each other.

In certain example embodiments, the engagement mechanism comprises magnetic attraction.

In certain example embodiments, the engagement mechanism comprises a plurality of clips.

In certain example embodiments, the engagement mechanism is positioned at least in part along a portion of the flexible bridge portion of the auxiliary eyewear.

### BRIEF DESCRIPTION OF THE DRAWINGS

Embodiments will now be described with reference to the appended drawings wherein:

FIG. 1 is a perspective view of an eyewear assembly and multiple types of auxiliary eyewear used in same.

FIG. 2 is a perspective view of an eyewear assembly.

FIG. 3a is a perspective view of the eyewear assembly of FIG. 2 illustrating a bending action.

FIG. 3b is a schematic view of the bending action shown in FIG. 3a.

FIG. 4a is a perspective view of the eyewear assembly of FIG. 2 illustrating another bending action.

FIG. 4b is a schematic view of the bending action shown in FIG. 4a.

FIG. 5 is a perspective view of another eyewear assembly.

FIG. 6 is a perspective view of the eyewear assembly of FIG. 6 illustrating a bending action.

FIG. 7 is a perspective view of the eyewear assembly of FIG. 6 illustrating another bending action.

FIG. 8 is a perspective view of another flexible eyewear assembly with an auxiliary eyewear.

FIG. 9 is an assembled view of the eyewear assembly shown in FIG. 8.

FIG. 10 is a partial plan view of a misaligned flexible eyewear assembly.

FIG. 11 is a partial plan view of the assembly of FIG. 8 showing alignment of the auxiliary and main eyewear frames.

FIG. 12 is a perspective view of the misaligned eyewear assembly of FIG. 10 on a wearer.

FIG. 13 is an overhead view of the misaligned eyewear assembly of FIG. 12 on a wearer.

FIG. 14 is a perspective view of the assembly of FIG. 8 on a wearer.

FIG. 15 is an overhead view of the assembly shown in FIG. 14 on a wearer.

FIG. 16 is an overhead view of the assembly of FIG. 8 showing a folded position imparted on the flexible eyewear assembly.

FIG. 17 is a perspective view illustrating the folded position of FIG. 16.

FIG. 18 is an overhead view of the assembly of FIG. 8 showing a twisted position imparted on the flexible eyewear assembly.

FIG. 19 is a perspective view illustrating the twisted position of FIG. 18.

FIG. 20 is an overhead view of the assembly of FIG. 8 showing an outwardly bent position imparted on the flexible eyewear assembly.

FIG. 21 is a perspective view illustrating the outwardly bent position of FIG. 20.

### DETAILED DESCRIPTION

It is recognized that further challenges arise when coupling flexible eyewear with accessories such as clip-on (or otherwise attachable) lenses (e.g., auxiliary sunglass lenses). In particular, the clip-on lenses may have difficulty staying attached when the primary eyewear is flexed, for example when the arms are folded inwardly or outwardly, which is exacerbated the more flexible the primary eyewear is. In previous attempts, clip-on lenses have been integrated with rigid frames to avoid dislodging of the clip-ons in use. It has been found that flexible eyewear can be paired with flexible clip-ons by aligning areas of flexibility between the two components in order to allow bending and stretching of the flexible material around each other and together to permit the same flexure to be applied in unison and maintain the releasable connection between the clip-on and the main eyewear. In other words, the alignment of the flexible portions and the choice of flexible material can permit “nested” bending together. Moreover, the attachment mechanism, such as clips, magnets, and the like, can be chosen to withstand the bending operation without making it difficult for a wearer to remove the clip-on from the main eyewear.

It can be appreciated that the term “clip-on” as used herein may be used interchangeably with other terms used to describe eyewear attachments that are releasably secured to a main flexible eyewear frame. As such, a clip-on referred to herein may refer to an auxiliary lens attached to a primary eyewear frame via magnetic attraction and not only using clips, snaps or other mechanical attachment mechanisms.

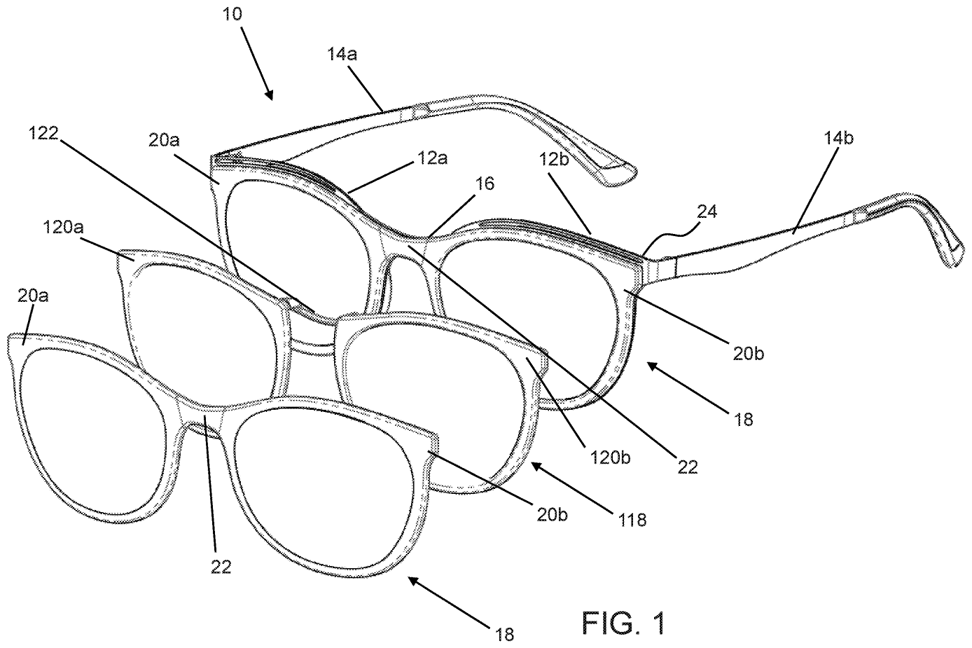

Turning now to the figures, FIG. 1 illustrates a perspective view of an example of primary eyewear 10 assembled with secondary or auxiliary eyewear 18, e.g., a clip-on or snap-on sunglass attachment. The primary eyewear 10 includes a pair of separate rigid frame portions 12, in this example a first rigid frame portion 12a and a second rigid frame portion 12b. A first arm 14a is connected to the first rigid frame portion 12a, and a second arm 14b is connected to the second rigid frame portion 12b. The first and second rigid frame portions 12a, 12b contain lenses, e.g., prescription lenses.

The rigid frame portions 12a, 12b are supported by and positioned relative to each other, and in turn positioned on either side of the user's head aligned with their eyes, through engagement with a flexible bridge component 16. The flexible bridge component 16 is connected to the rigid frame portions 12a, 12b using any suitable mechanism, e.g., a mechanical connection, overmolding, bonding, etc.

The auxiliary eyewear 18 also includes a pair of separate rigid frame portions 20, in this example a first rigid frame portion 20a and a second rigid frame portion 20b. As with the primary eyewear 10, the auxiliary eyewear 18 includes a flexible bridge portion 22 that connects the rigid frame portions 20a, 20b to each other. The flexible bridge portions 16, 22 are substantially similar in length such that they are aligned with each other when the frame portions 12, 20 are aligned with each other, as described in greater detail below.

FIG. 1 also shows a second example of auxiliary eyewear 118, wherein similar elements are numbered using the prefix “1”. In the second example of auxiliary eyewear 118 it may be noted that a flexible bridge portion 122 used to couple first and second rigid frame portions 120a, 120b has a similar lengthwise dimension when compared to the flexible bridge portions 16, 22, but is relatively more slender and may be positioned to fit atop or above the flexible bridge portion 16 when the auxiliary eyewear 118 is coupled to the primary eyewear 10. As such, it can be appreciated that the flexible bridge portion 22, 122 of the auxiliary eyewear 18, 118 may take different forms. The two examples of auxiliary eyewear 18, 118 are shown together in FIG. 1 for ease of comparison with each other and to show positioning and alignment of the flexible bridge portions 16, 18, 118 in either example. Also shown in FIG. 1 is an engagement 24 between the primary eyewear 10 and the auxiliary eyewear 18. It can be appreciated that the engagement 24 may refer to any releasably attachable/detachable connection for the purpose of attaching and removing the auxiliary eyewear 18, such as, without limitation, clips, snaps, magnets, magnetic material, frictional engagement, etc. The mechanism chosen to releasably attach/detach the auxiliary eyewear 18 may be positioned at various connection points, including at any point along or around the auxiliary eyewear 18 and/or the primary eyewear 10, including portions around the lenses on either or both frame portions 20a/120a, 20b/120b, along or at the flexible bridge portion 16/122, towards the temple regions, etc.

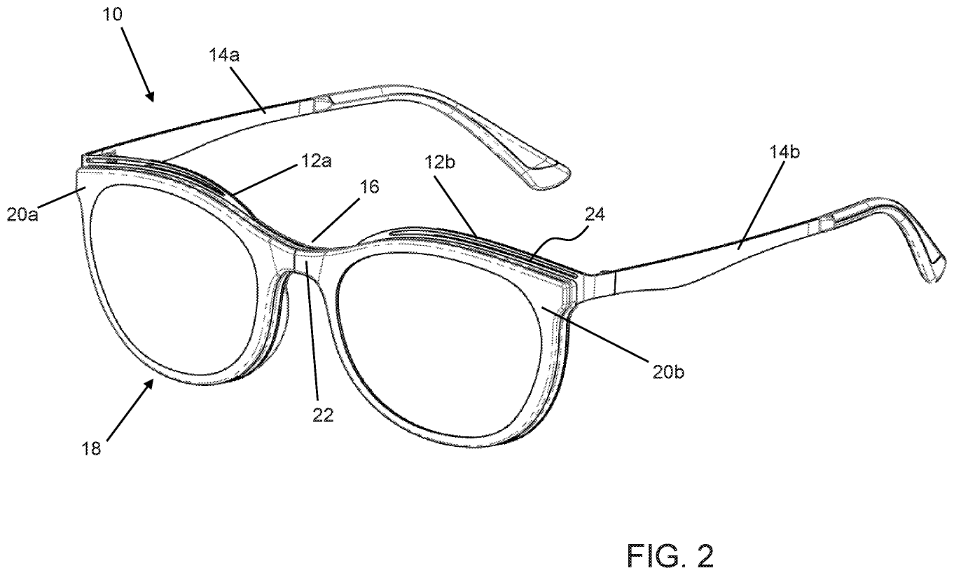

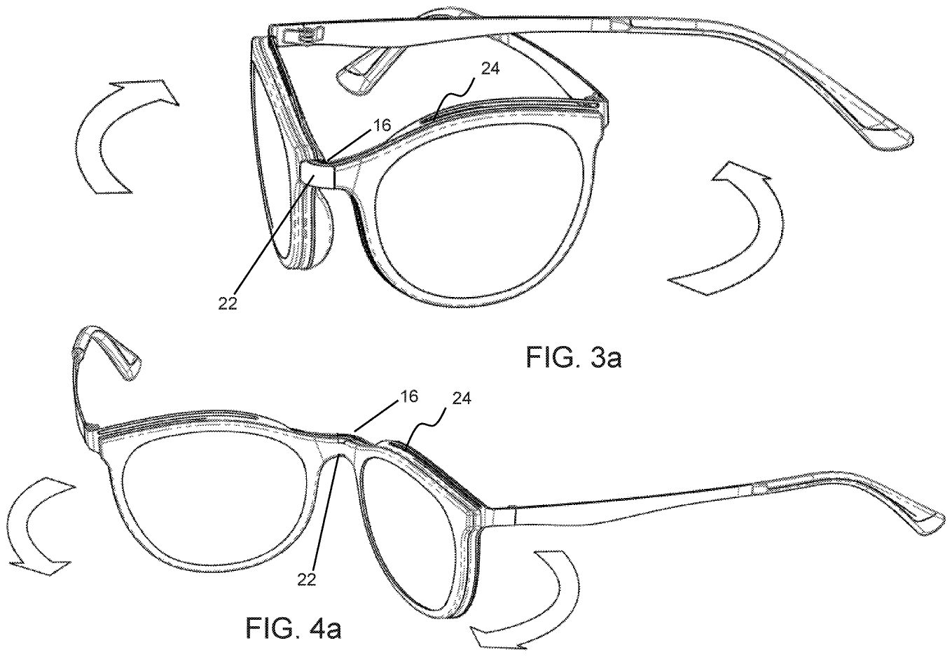

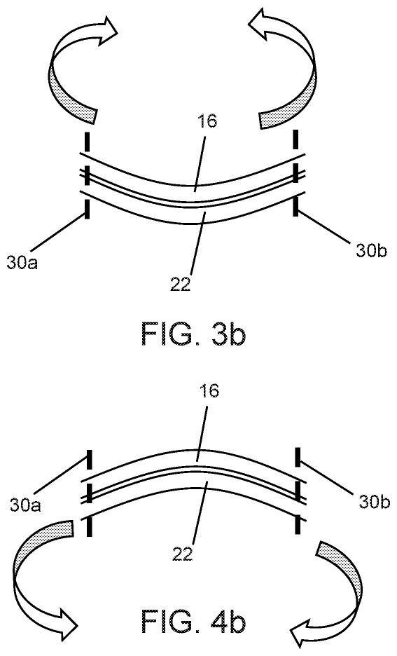

Referring now to FIGS. 2, 3a, and 4a, the assembled primary and auxiliary eyewear 10, 18 is shown. In FIG. 2, the assembled primary and auxiliary eyewear 10, 18 is in a rest position, also referred to herein as the wearable or normal position/configuration. FIG. 3a illustrates a first folding action where the primary eyewear 10 and the auxiliary eyewear 18 bend together in unison. This is possible since the flexible bridge portion 16 of the primary eyewear 10 is substantially similar in the lengthwise direction and substantially aligned with the flexible bridge portion 22 of the auxiliary eyewear 18. In this way, the pieces may flex together while maintaining the engagement 24 therebetween. This alignment is shown in more detail in the schematic view of FIG. 3b in which the flexibility provided between the boundaries 30a, 30b permit the unison bending as shown in FIG. 3a.

Likewise, in FIG. 4a, a second folding action is shown, where the primary eyewear 10 and the auxiliary eyewear 18 bend together in unison in the opposite direction. This requires the flexible bridge portions 16, 22 to be capable of bending in both directions and having the alignment between the boundaries 30a, 30b as shown in FIG. 4b.

In addition to bending together, the flexible bridge portions 16, 22 can possess at least some stretchability in order to permit the deforming over and around each other as they bend in unison as shown in FIGS. 3b and 4b. This allows the engagement 24 between the eyewear 10, 18 to have minimal shifting laterally which could lead to dislodgement depending on the type of engagement (e.g., individual magnets or clips). In an embodiment, a portion of magnetic material, coating, paint or portion of the frame portions 12, 20 can be used to increase the contact surface area between the eyewear 10, 18. Moreover, the amount of magnetic attraction may then be controlled according to a desired amount of engagement 24 needed based on the flexibility of the bridge portions 16, 22 and the difficulty/ease of decoupling desired.

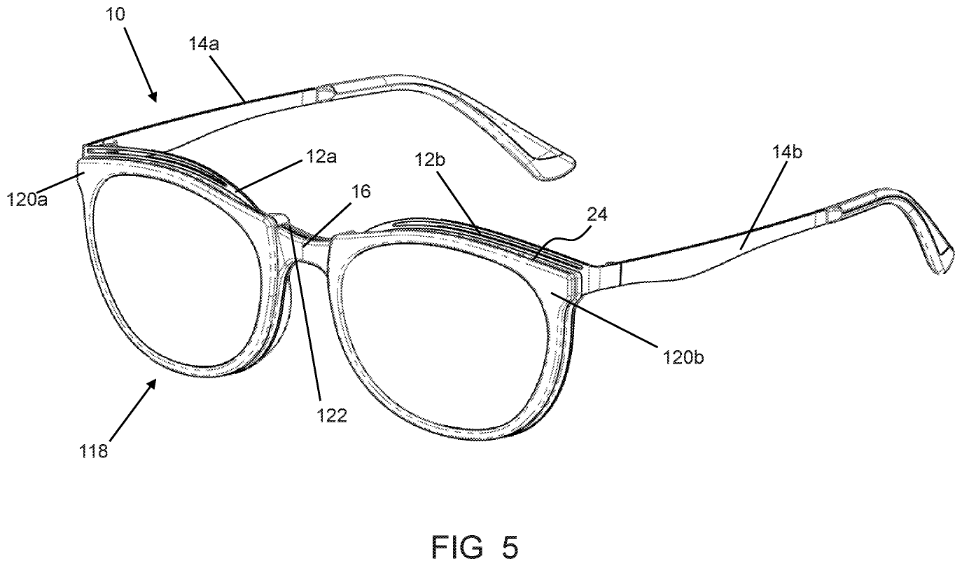

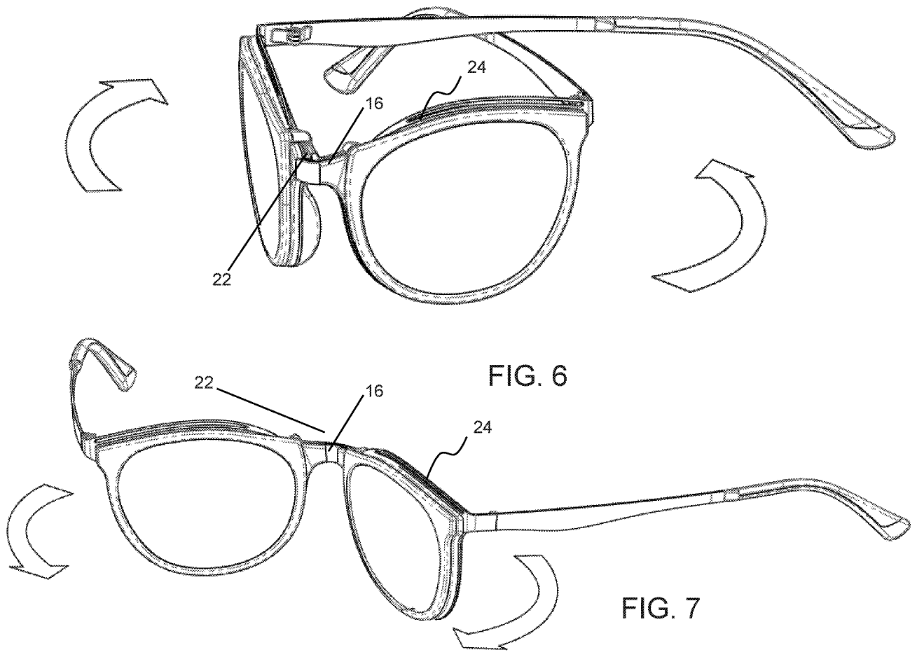

FIGS. 5, 6, and 7 illustrate similar principles applied to the assembly of eyewear 10, 118. In this example, the flexible bridge portion 122 of the auxiliary eyewear 118 includes a relatively slender portion of flexible material that may sit atop or above the flexible bridge portion 16. However, as seen in FIG. 6 or 7, the flexible bridge portion 122 is aligned with and can bend in unison with the flexible bridge portion 16 and thus illustrates that with consistent alignment, the shape, contours, bulk and overall size of the flexible bridge portion 22, 122 can vary and achieve the desired flexibility in unison described herein.

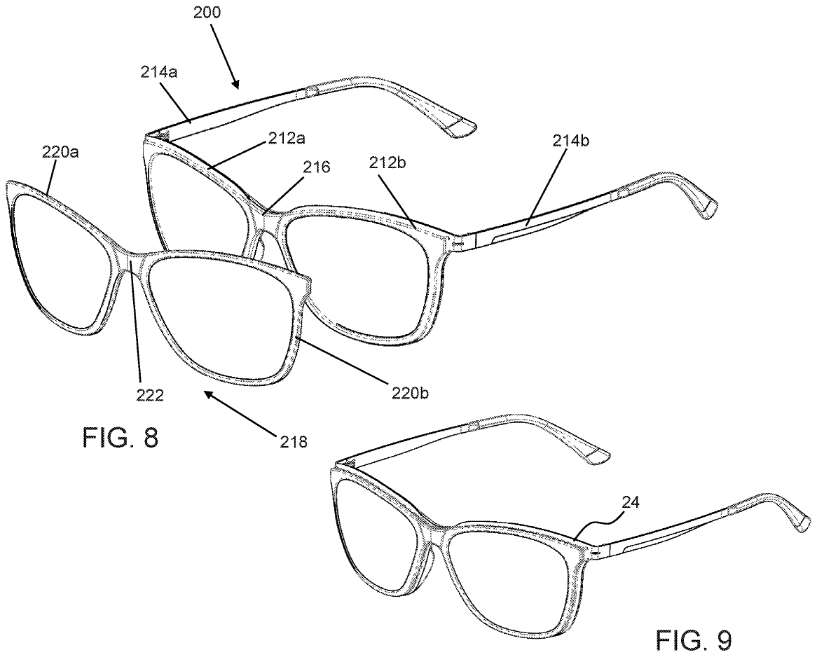

FIGS. 8 and 9 illustrate another eyewear assembly 200 to further illustrate how the combination of a flexible auxiliary eyewear 218 can be supported by and remain attached to a flexible primary eyewear 200 despite large degrees of flexibility. In FIG. 8, like elements with respect to FIG. 1 are given like numerals with the prefix “2” and thus certain details above with respect to the naming and functionality need not be reiterated. As shown in FIG. 8, the auxiliary eyewear 218 includes a flexible bridge portion 222 that is similar in size, contour and configuration to the flexible bridge portion 216 of the primary eyewear 200. In this way, when coupled to each other via the chosen attachment mechanism (e.g., magnetic force, clip-ons, etc.), there is a flush fitment as shown in FIG. 9 without misalignment.

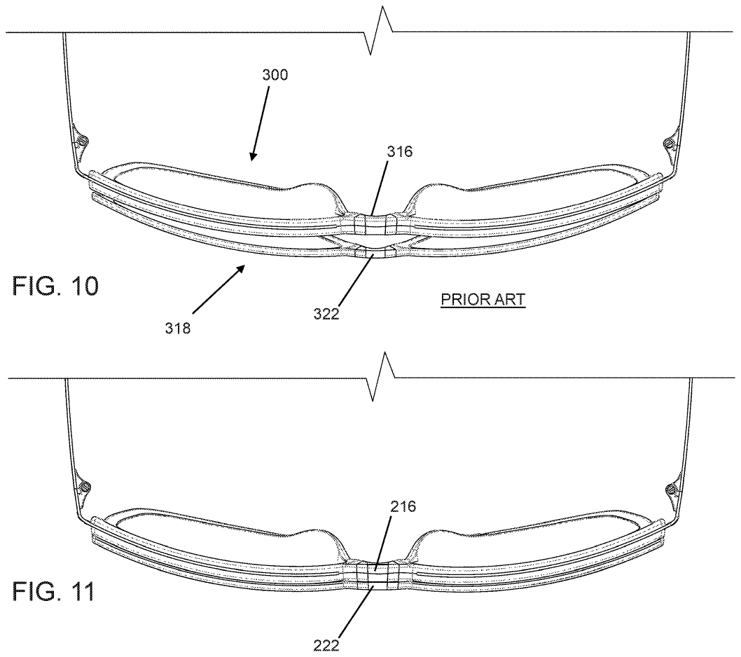

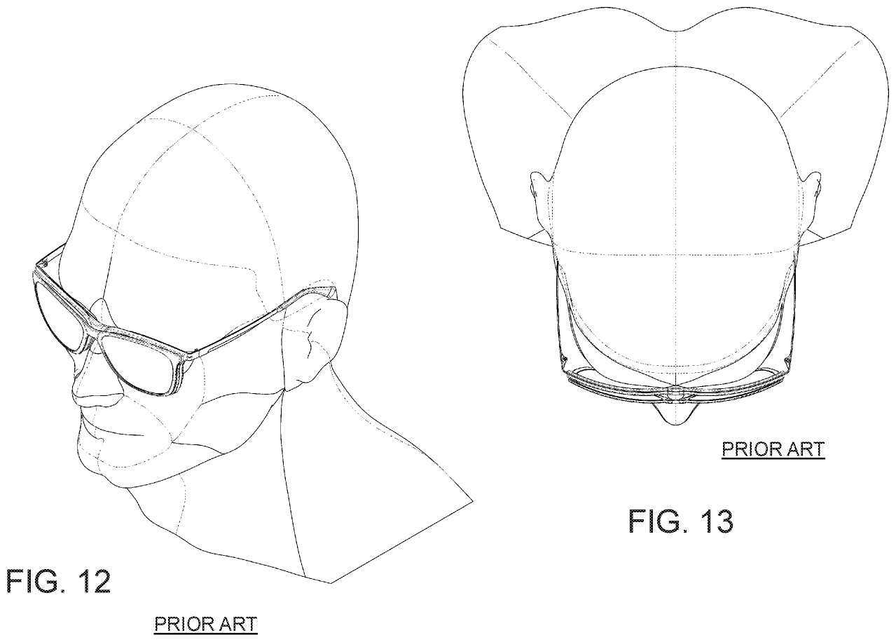

Referring now to a prior art issue shown in FIG. 10, it has been found that current clip-on eyewear 318 when coupled to a flexible primary eyewear 300 creates a misalignment between the bridge portion 322 of the clip-on eyewear 318 and the flexible bridge portion 316 of the primary eyewear 300. This is because flexible primary eyewear 300 primarily bends and flexes about the bridge portion due to the way the eyewear 300 is seated on a user's face. Moreover, current clip-on attachments are not configured to accommodate any movements and may therefore pop off the primary eyewear 300 if bent too far. This may also cause the clip-on eyewear 318 to not sit flush with the front surface of the front frame. As a result, any twisting or bending or folding of the primary eyewear 300 is prone to dislodgement of the clip-on eyewear 318. This prior art issue is further illustrated in FIGS. 12 and 13 where the gap between the eyewear 300, 318 is evident. With such current implementations, the only way to counter this misalignment is to either adjust the frame temples 314a, b so that the front frame does not deform, or adjust the clip-on eyewear 318. In both cases, there is no self-adjustment of the frames 300, 318 which can be achieved by the flexible eyewear 200, 218 as shown in FIGS. 8 and 9.

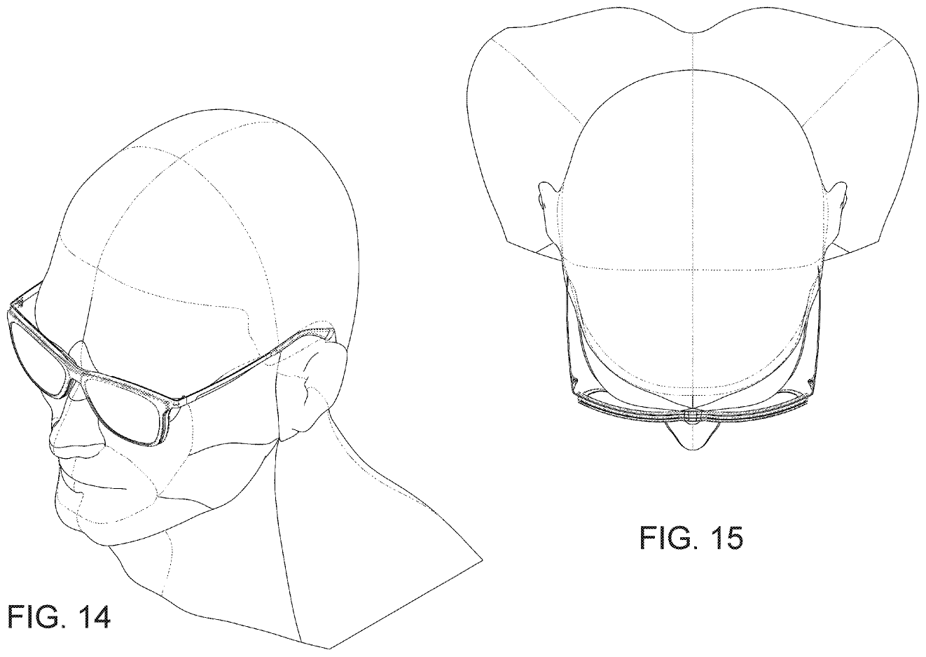

FIGS. 11, 14 and 15 illustrate how the arrangement shown in FIGS. 8 and 9 can avoid such misalignment. Here, the contouring and shape of the flexible auxiliary eyewear 218 (i.e. engaging faces thereof) can reduce or even eliminate the gap between the matched flexible bridge portions 216, 222, such that when seated on the wearer as shown in FIGS. 14 and 15, any bending or twisting as a result of placing or removing or other impacts or stresses on the eyewear assembly can be absorbed and accommodated without unintentional dislodgement of the auxiliary eyewear 218 from the primary eyewear 200.

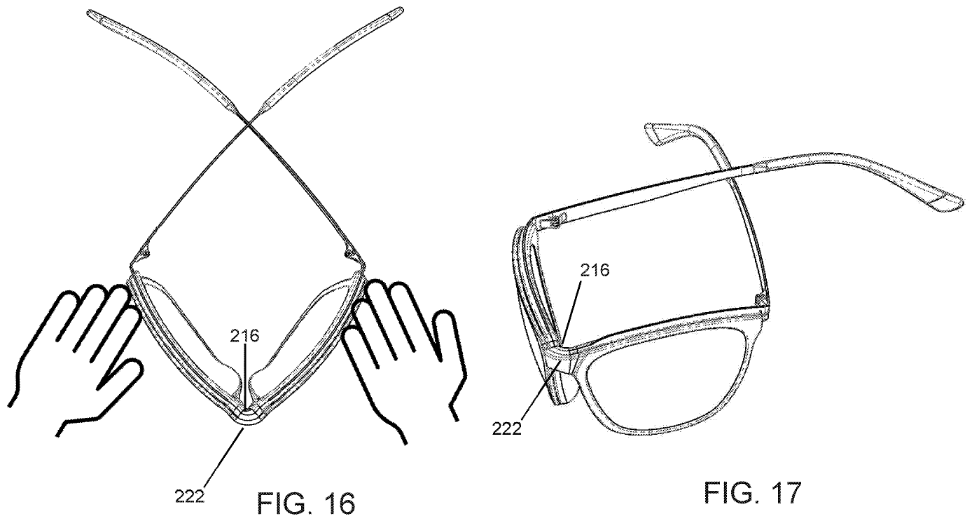

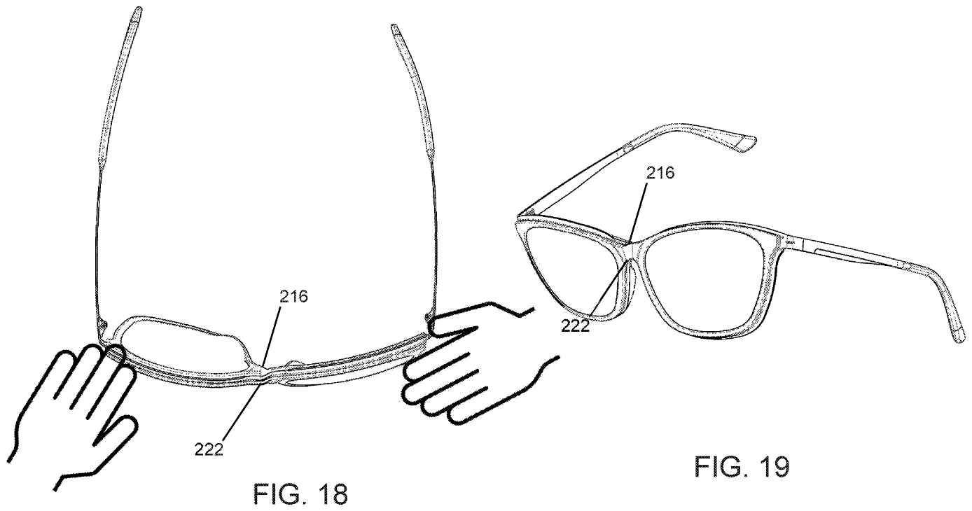

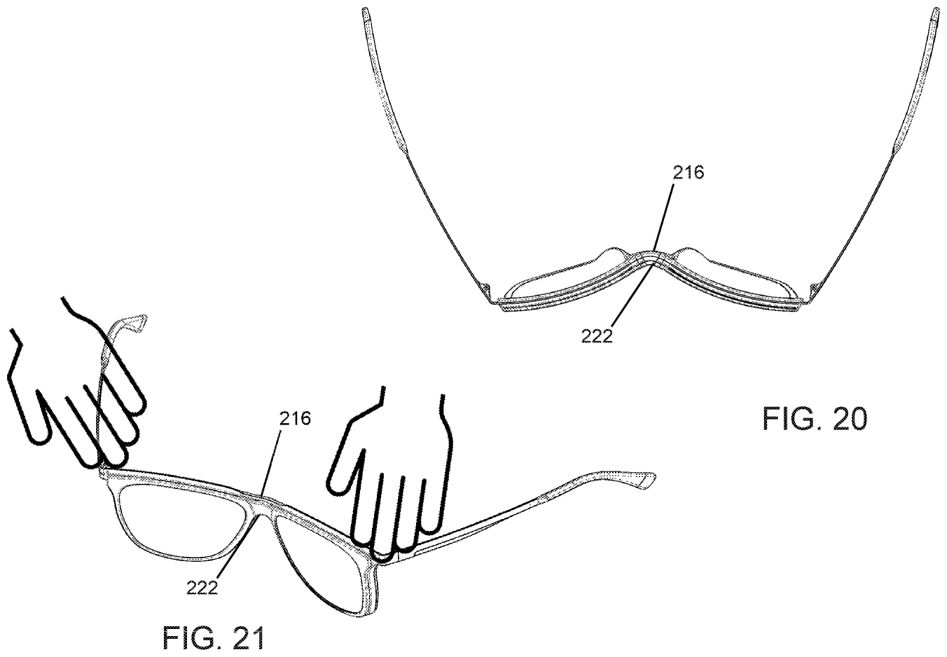

FIGS. 16 and 17 illustrate that a significant folding motion when a user's hands bend the lenses towards each other can be absorbed due to the alignment and close fitment of the flexible bridge portions 216, 222, e.g., as shown above in FIGS. 3b and 4b. Similarly, FIGS. 18 and 19 illustrate the same close fitment and accommodation of a twisting motion by a user and FIGS. 20 and 21 the same for an outward bending motion. It may be noted that in any of these relatively extreme flexible deformations, the auxiliary eyewear 218 can flex with the primary eyewear 200 and its front surface thus self-adjusting to the deformations.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

Although the above principles have been described with reference to certain specific examples, various modifications thereof will be apparent to those skilled in the art as having regard to the appended claims in view of the specification as a whole.

1. Flexible auxiliary eyewear configured to be releasably attached to flexible primary eyewear by including at least a portion of flexible material that is aligned with a flexible portion of the flexible primary eyewear.

2. Flexible auxiliary eyewear of claim 1, wherein the flexible auxiliary eyewear comprises a flexible bridge portion that deforms to follow the deformation permitted by the flexible primary eyewear to maintain the auxiliary eyewear flush to a front surface of the primary eyewear frame.

3. Flexible auxiliary eyewear of claim 2, wherein the flexible bridge portion permits bending and twisting to follow bending and twisting permitted by the flexible primary eyewear.

4. Flexible auxiliary eyewear of claim 1, comprising an engagement mechanism to couple the flexible auxiliary eyewear to the flexible primary eyewear.

5. Flexible auxiliary eyewear of claim 4, wherein the engagement mechanism comprises magnetic attraction.

6. Flexible auxiliary eyewear of claim 4, wherein the engagement mechanism comprises one or more clips.

7. Flexible auxiliary eyewear of claim 4, wherein the engagement mechanism is positioned at a plurality of portions of a frame of the flexible auxiliary eyewear.

8. Flexible auxiliary eyewear of claim 4, wherein the engagement mechanism is positioned at least in part along a portion of the flexible portion of the flexible auxiliary eyewear.

9. Flexible auxiliary eyewear of claim 3, wherein the flexible bridge portion comprises a length that substantially spans the same length as a flexible bridge portion of the flexible primary eyewear.

10. Flexible auxiliary eyewear of claim 1, wherein the flexible auxiliary eyewear comprises a surface that is contoured to follow contouring of a front face of the flexible primary eyewear.

11. An eyewear assembly comprising:
flexible auxiliary eyewear configured to be releasably attached to flexible primary eyewear by including at least a portion of flexible material that is aligned with a flexible portion of the flexible primary eyewear; and
the flexible primary eyewear.

12. An eyewear assembly, comprising:
primary eyewear, the primary eyewear comprising a first pair of frame portions configured to contain a first pair of lenses, the first pair of frame portions connected to each other via a first flexible bridge portion; and
auxiliary eyewear, the auxiliary eyewear comprising a second pair of frame portions configured to contain a second pair of lenses, the second pair of frame portions connected to each other via a second flexible bridge portion;
wherein the first and second pairs of frame portions are releasably attachable to each other via an engagement mechanism; and
wherein the first and second flexible bridge portions are substantially aligned with each other when the first and second pairs of frame portions are engaged with each other to permit the primary and auxiliary eyewear to bend in unison while maintaining engagement with each other.

13. The eyewear assembly of claim 12, wherein the engagement mechanism comprises magnetic attraction.

14. The eyewear assembly of claim 12, wherein the engagement mechanism comprises a plurality of clips.

15. The eyewear assembly of claim 12, wherein the engagement mechanism is positioned at least in part along a portion of the flexible bridge portion of the auxiliary eyewear.
